(19) United States
(12) Patent Application Publication
(10) Pub. No.: US 2009/0259812 A1
(43) Pub. Date: Oct. 15, 2009

(54) Storage system and data saving method

(75) Inventors: Koji Iwamitsu, Odawara (JP); Junji Ogawa, Sagamihara (JP); Yuko Matsui, Odawara (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/213,851

(22) Filed: Jun. 25, 2008

(30) Foreign Application Priority Data
Apr. 9, 2008 (JP) 2008-101846

(51) Int. Cl. G06F 12/00

(52) U.S. Cl. 711/114; 711/E12.001

(57) ABSTRACT

This storage system includes a plurality of data drives, a plurality of spare drives for storing data stored in at least one data drive among the plurality of data drives as save-target data, one or more RAID groups configured from the plurality of data drives, one or more spare RAID groups associated with the one or more RAID groups and configured from the plurality of spare drives, and a write unit to configured to write the save-target data into the plurality of spare drives configuring the one or more spare RAID groups in the order that the save-target data was read from the at least one data drive.

### CROSS-REFERENCES

This application relates to and claims priority from Japanese Patent Application No. 2008-101846, filed on Apr. 9, 2008, the entire disclosure of which is incorporated herein by reference.

### BACKGROUND

The present invention generally relates to a storage system and a data saving method, and in particular relates to technology for writing data into a spare drive.

Conventionally, a plurality of hard disk drives are mounted on a storage apparatus of a storage system. The reliability of the storage system is improved by managing the plurality of hard disk drives in RAID format.

If a failure occurs to one of the hard disk drives among the plurality of hard disk drives, a method of saving the data stored in the failed hard disk drive (hereinafter referred to as the “data drive”) to a spare hard disk drive (hereinafter referred to as the “spare drive”) pre-mounted on the storage apparatus is known. Nevertheless, only one spare drive can be used in the RAID group configured for restoring data in the failed data drive. Thus, it takes much time to save the data in the data drive to the spare drive, and it also takes much time to write the data saved in the spare drive into a replaced data drive. In addition, due to the capacity shortage of the spare drive, there are cases where the data in the failed data drive cannot be fully written into the spare drive, which in turn means that the data in the failed data drive cannot be restored.

Japanese Patent Laid-Open Publication No. 2005-149374 (Patent Document 1) discloses technology of mounting a plurality of spare drives, and saving data in a failed data drive to a pool area configured from such plurality of spare drives.

### SUMMARY

According to the technology disclosed in Patent Document 1, although it is not necessary to give consideration to the physical capacity of the spare drive, it is not possible to achieve a redundant configuration of the spare drive. Moreover, since no consideration is given to the physical capacity of the spare drive, it is not possible to sequentially write data into the physical spare drive. Patent Document 1 does not describe the specific management method of data to be written into a spare RAID group or the specific management method regarding the capacity of the data to be written or the capacity of the pool area which will be required when realizing a redundant configuration and sequentially writing data into the spare drive.

Thus, an object of the present invention is to propose a storage system and a data saving method enabling efficient management by realizing a redundant configuration of a spare drive and sequentially writing data into the spare drive.

In order to achieve the foregoing object, the present invention provides a storage system comprising a plurality of data drives, a plurality of spare drives for storing data stored in at least one data drive among the plurality of data drives as save-target data, one or more RAID groups configured from the plurality of data drives, one or more spare RAID groups associated with the one or more RAID groups and configured from the plurality of spare drives, and a write unit to configured to write the save-target data into the plurality of spare drives configuring the one or more spare RAID groups in the order that the save-target data was read from the at least one data drive.

Consequently, redundancy of the spare drive can be realized by configuring the plurality of spare drives in RAID format. Moreover, the performance of the storage system can be improved since the save-target data can be sequentially written into the plurality of spare drives in the order that it was read.

The present invention additionally provides a data saving method comprising a step of configuring one or more RAID groups from a plurality of data drives, a step of storing data stored in at least one data drive among the plurality of data drives as save-target data in a plurality of spare drives, a step of configuring one or more spare RAID groups associated with one or more spare RAID groups from the plurality of spare drives, and a step of writing the save-target data into the plurality of spare drives configuring the one or more spare RAID groups in the order that the save-target data was read from the at least one data drive.

Consequently, redundancy of the spare drive can be realized by configuring the plurality of spare drives in RAID format. Moreover, the performance of the storage system can be improved since the save-target data can be sequentially written into the plurality of spare drives in the order that it was read.

According to the present invention, it is possible to efficiently manage a storage system by realizing a redundant configuration of a spare drive and sequentially writing data in to the spare drive.

Furthermore, it is possible to efficiently manage a storage system since a plurality of RAID groups configured from a plurality of data drives share one spare drive.

### DESCRIPTION OF DRAWINGS

FIG. 1 is a block diagram showing the configuration of a storage system according to an embodiment of the present invention;

FIG. 2 is a chart showing the contents of a main memory according to an embodiment of the present invention;

FIG. 3 is a chart showing a drive management information table according to an embodiment of the present invention;

FIG. 4 is a chart showing a data drive management information table according to an embodiment of the present invention;

FIG. 5 is a chart showing a spare drive management information table according to an embodiment of the present invention;

FIG. 6 is a chart showing a log table according to an embodiment of the present invention;

FIG. 7 is a flowchart showing the change processing according to an embodiment of the present invention;

FIG. 8 is flowchart showing the conventional write processing;

FIG. 9 is a flowchart showing the write processing according to an embodiment of the present invention;

FIG. 10 is a conceptual diagram showing the write processing according to an embodiment of the present invention;

FIG. 11 is a flowchart showing the reconfiguration time setting processing according to an embodiment of the present invention;

FIG. 12 is a flowchart showing the write update processing according to an embodiment of the present invention;

FIG. 13 is a conceptual diagram showing the write update processing according to an embodiment of the present invention;

FIG. 14 is a flowchart showing the copyback processing according to an embodiment of the present invention; and

FIG. 15 is a conceptual diagram showing the copyback processing according to an embodiment of the present invention.

### DETAILED DESCRIPTION

An embodiment of the present invention is now explained in detail with reference to the attached drawings.

(1) Configuration of Storage System in Present Embodiment

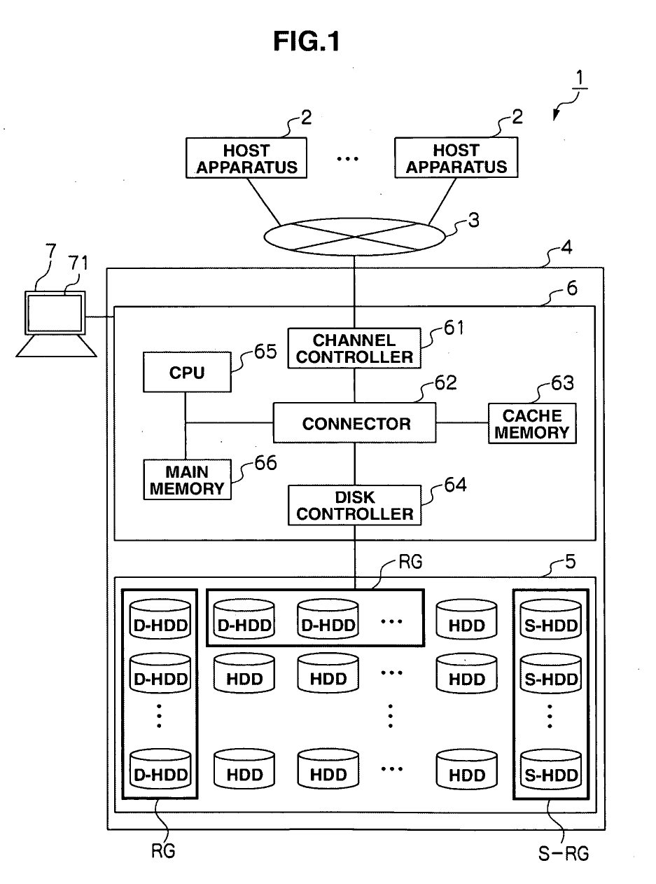

FIG. 1 shows the overall storage system 1 according to the present embodiment. The storage system 1 is configured by a host apparatus 2 being connected to a storage apparatus 4 via a network 3, and the storage apparatus 4 being connected to a management terminal 7.

The host apparatus 2 is a computer device comprising information processing resources such as a CPU 65 and a memory, and is configured from a personal computer, a workstation, a mainframe or the like. The host apparatus 22 additionally comprises an information input device (not shown) such as a keyboard or a switch, and an information output device (not shown) such as a monitor display or a speaker.

The network 3 is configured from a SAN (Storage Area Network), a LAN (Local Area Network), Internet, a public line, a dedicated line or the like. For instance, data is transferred according to a fibre channel protocol if the network 3 is a SAN, and data is transferred according to a TCP/IP protocol if the network 3 is a LAN. In this embodiment, a SAN is used as the network 3 for connecting the host apparatus 2 and the storage apparatus 4.

The storage apparatus 4 comprises a disk unit 5 configured from a plurality of hard disk drives HDD, and a controller unit 6 that manages a plurality of hard disks in RAID format.

The hard disk drives HDD are configured from expensive disks such as SCSI disks with high access performance, or inexpensive disks such as SATA disks or optical disks with low access performance.

The hard disk drives HDD can be classified into data drives D-HDD for storing data from the host apparatus 2 and the parity data of such data, and spare drives S-HDD for saving data (including parity data) stored in a failed data drive D-HDD.

In the disk unit 5, a plurality of data drives D-HDD configure a data RAID group RG (hereinafter referred to as the “data RAID group RG”), and a plurality of spare drives S-HDD configure a spare RAID group S-RG (hereinafter referred to as the “spare RAID group S-RG”).

Here, a data RAID group RG is a group managed by the storage apparatus 4 in RAID format and a group that is able to recover the data stored in a failed data drive D-HDD, and there is no limitation on the number of data drives D-HDD that can configure a group.

Moreover, a spare RAID group S-RG is a group that is managed by the storage apparatus 4 in RAID format and a group that is configured from two or more spare drives S-HDD. Data stored in the failed data drive D-HDD is distributively stored in the two or more spare drives S-HDD configuring the spare RAID group S-RG.

Although the RAID level is optimally a RAID 3 or RAID 4 level capable of sequentially writing data, the configuration is not limited to these levels.

One or more logical volumes (not shown) are defined in a storage area provided by one data RAID group RG.

A unique identifier LUN (Logical Block Number) is allocated to the logical volumes. The input and output of data is performed by designating an address which combines this identifier and a unique number LBA (Logical Block Addressing) allocated to blocks obtained by logically partitioning the logical volume.

A storage area provided by one spare RAID group S-RG is referred to as a pool area.

The controller unit 6 comprises a channel controller 61, a connector 62, a cache memory 63, a disk controller 64, a CPU 65, and a main memory 66.

The channel controller 61 functions as an interface to the host apparatus 2, and sends and receives various commands and data to and from the host apparatus 2. The channel controller 61 interprets the various commands sent from the host apparatus 2 and executes necessary processing.

The connector 62 is configured from a mutually connectable switch or a bus. The sending and receiving of data and commands among the channel controller 61, the disk controller 64, the cache memory 63, the main memory 66 and the CPU 65 are conducted via the connector 62.

The disk controller 64 functions as an interface for performing protocol control during the communication with the disk unit 5. The disk controller 64 is connected to a corresponding disk unit 5 via a fibre channel cable or the like, and sends and receives data to and from the disk unit 5 according to a fibre channel protocol.

The cache memory 63 is a storage memory to be shared by the channel controller 61 and the disk controller 64. The cache memory 63 is primarily used for temporarily storing data to be input and output to and from the storage apparatus 4.

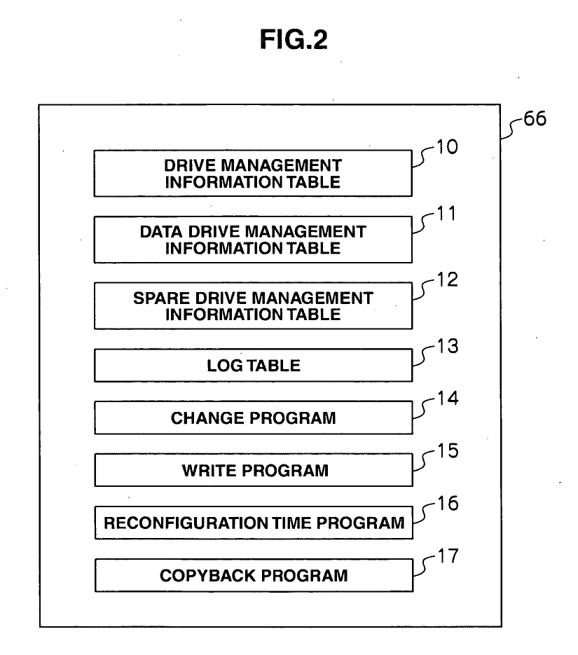

The main memory 66 is also a storage memory to be shared by the channel controller 61 and the disk controller 64. The main memory 66 is primarily used for storing system configuration information, various control programs, and commands from the host apparatus 2. In addition, the main memory 66 stores, as shown in FIG. 2, a drive management information table 10, a data drive management information table 11, a spare drive management information table 12, a log table 13, a change program 14 for changing the setting when a data RAID group RG is added or deleted, a write program 15 for writing data stored in a failed data drive D-HDD into a spare drive S-HDD, a reconfiguration time program 16 for setting the reconfiguration time required for writing back the data to a replaced data drive D-HDD, and a copyback program 17 for writing back data from the spare drive S-HDD to the replaced data drive D-HDD. The various tables stored in the main memory 66 will be described later.

Returning to FIG. 1, the CPU 65 is a central processing unit that reads and interprets the programs in the main memory 66, and migrates or otherwise processes the data according to the obtained result. The CPU 65 is connected directly, or via the connector 62, to the channel controller 61, the disk controller 64, the cache memory 63, and the main memory 66 for exchanging data and programs.

The management terminal 7 is a computer device that is operated for managing the storage apparatus 4, and is configured from a personal computer or the like. The management terminal 7 manages the association of the data RAID group RG and the spare RAID group S-RG, and sets the reconfiguration time required for writing back data to a replaced data drive D-HDD. The management terminal 7 comprises a management screen 71 for performing this kind of management processing and setting processing.

(2) Configuration of Tables

The respective configurations of the drive management information table 10, the data drive management information table 11, the spare drive management information table 12, and the log table 13 stored in the main memory 66 are now explained.

(2-1) Drive Management Information Table

The drive management information table 10 is a table for managing information required for the storage apparatus 4 to control the hard disk drive HDD as a data drive D-HDD and a spare drive S-HDD.

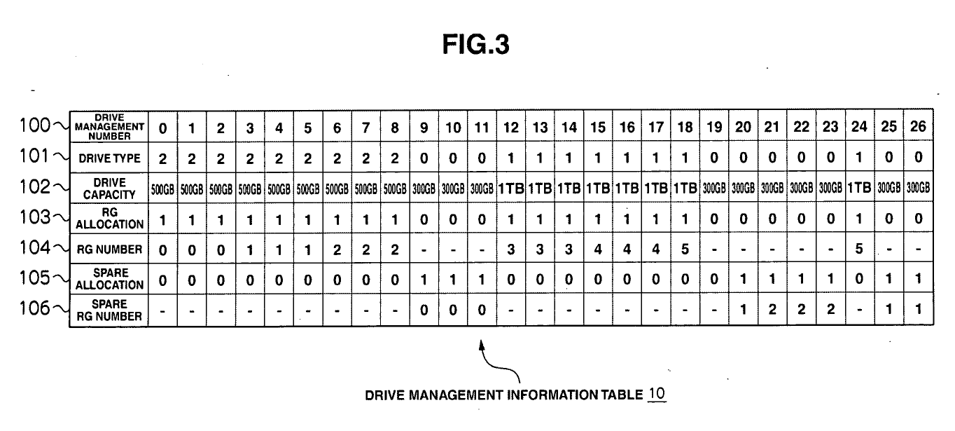

As shown in FIG. 3, the drive management information table 10 is configured from a “drive management number” column 100, a “drive type” column 101, a “drive capacity” column 102, an “RG allocation” column 103, an “RG number” column 104, a “spare allocation” column 105, and a “spare RG number” column 106.

The “drive management number” column 100 stores the identification number of all hard disk drives HDD mounted on the storage apparatus 4 for using the hard disk drive HDD as a data drive D-HDD or a spare drive S-HDD.

The “drive type” column 101 stores the type information of drives that are classified according to the difference in the communication interface of the controller unit 6 and the hard disk drive HDD. For example, in the “drive type” column 101, “2” is stored for a SAS disk, “1” is stored for a SATA disk, and “0” is stored for an FC disk.

The “drive capacity” column 102 stores the capacity of one hard disk drive HDD.

The “RG allocation” column 103 stores information regarding whether the hard disk drive HDD is being used as a data drive D-HDD and whether that hard disk drive HDD belongs to a data RAID group RG. For example, if the hard disk drive HDD belongs to a data RAID group RG, “1” is stored since it means that the hard disk drive HDD has been allocated to a RAID group. Meanwhile, if the hard disk drive HDD does not belong to a data RAID group RG, “0” is stored since it means that the hard disk drive HDD has not been allocated to a RAID group.

The “RG number” column 104 stores the affiliated data RAID group number when the hard disk drive HDD is being used as the data drive D-HDD. Thus, if the hard disk drive HDD does not belong to a data RAID group RG, a data RAID group number is not assigned (indicated as “-” in FIG. 3).

The “spare allocation” column 105 stores information regarding whether the hard disk drive HDD is being used as a spare drive S-HDD and whether that hard disk drive HDD belongs to a spare RAID group S-RG. For example, if the hard disk drive HDD belongs to a spare RAID group S-RG, “1” is stored since it means that the hard disk drive HDD has been allocated to a RAID group. Meanwhile, it the hard disk drive HDD does not belong to a spare RAID group S-RG, “0” is stored since it means that the hard disk drive HDD has not been allocated to a RAID group.

The “spare RG number” column 106 stores the affiliated spare RAID group number when the hard disk drive HDD is being used as a spare drive S-HDD. Thus, if the hard disk drive HDD does not belong to a spare RAID group S-RG, a spare RAID group number is not assigned (indicated as “-” in FIG. 3).

(2-2) Data Drive Management Information Table

The data drive management information table 11 is a table for managing the data drive D-HDD for each data RAID group RG, and is used for associating the data RAID group RG and the spare RAID group S-RG. If a failure occurs in a data drive D-HDD belonging to the data RAID group RG, data in the failed data drive D-HDD is saved to a spare drive S-HDD belonging to the spare RAID group S-RG associated in the data drive management information table 11.

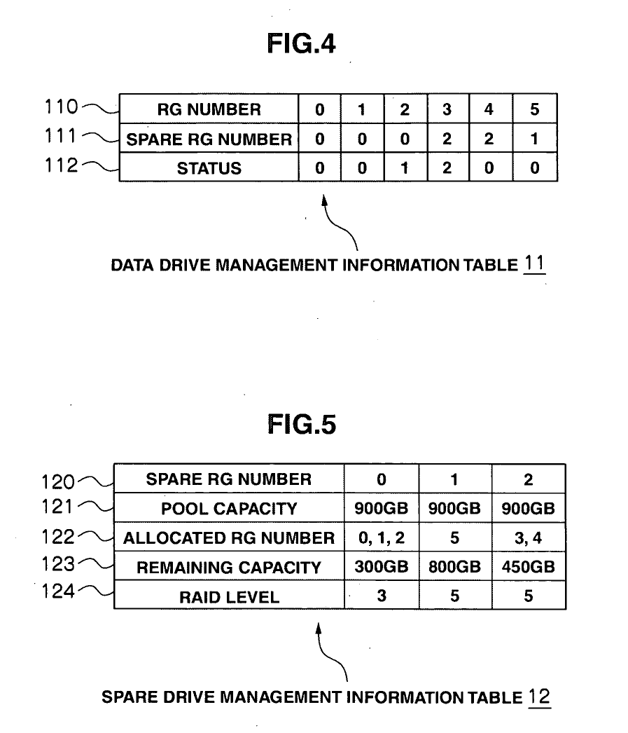

As shown in FIG. 4, the data drive management information table 11 is configured from an “RG number” column 110 showing the data RAID group number, a “spare RG number” column 111 showing the spare RAID group number associated with the data RAID group RG, and a “status” column 112.

The “status” column 112 stores information on the status of the data drive D-HDD belonging to that data RAID group RG. For example, “0” is stored if the data drive D-HDD belonging to that data RAID group RG is operating normally, “1” is stored when a failure has occurred, and “2” is stored when data has been saved to the spare drive S-HDD belonging to the associated spare RAID group S-RG. Moreover, “3” is stored when the saving of data in the data drive D-HDD is complete, “4” is stored if a failed data drive D-HDD is replaced with a new data drive D-HDD, and “5” is stored when data is being written back from the spare drive S-HDD to the replaced data drive D-HDD.

(2-3) Spare Drive Management Information Table

The spare drive management information table 12 is a table for managing the spare drive S-HDD for each data RAID group RG, and is used for associating the spare RAID group S-RG and the data RAID group RG.

As shown in FIG. 5, the spare drive management information table 12 is configured from a “spare RG number” column 120 showing the spare RAID group number, a “pool capacity” column 121 showing the entire storage area of the spare drives S-HDD configuring the spare RAID group S-RG, an “allocated RG number” column 122 showing the data RAID group number associated with the spare RAID group S-RG, a “remaining capacity” column 123 showing the unused storage area of the spare drive S-HDD configuring the spare RAID group S-RG, and a “RAID level” column 124 showing the spare RAID level.

(2-4) Log Table

The log table 13 is a table for managing the save-target data to be written into the spare drive S-HDD. The save-target data is managed in the log table 13 in the order that it is sent from the failed data drive D-HDD to the main memory 66.

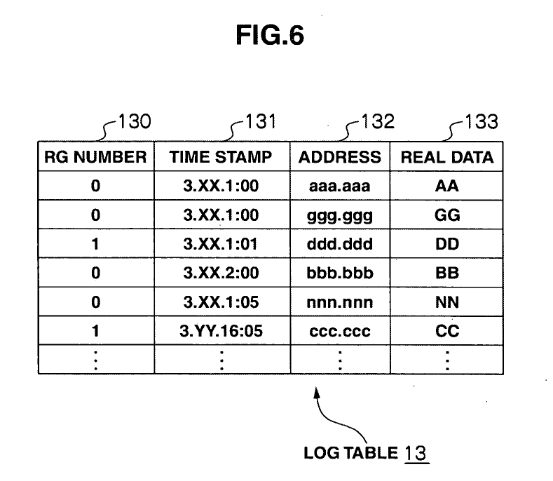

As shown in FIG. 6, the log table 13 is configured from an “RG number” column 130 showing the data RAID group number, a “time stamp” column 131 showing the log information recording the date and time for writing the save-target data into the spare drive S-HDD, an “address” column 132 showing the location where the save-target data is stored in the data drive D-HDD, and a “real data” column 133 showing the content of the save-target data.

The log table 13 manages the RAID group number information, the time stamp information, and the address information (data-related information R) by associating such information with data. Data-related information is identifying information of the save-target data that can be written into the spare drive in the order that it was read into the memory.

Although this embodiment explains a case of adopting the log format of managing the save-target data according to the date and time that it is to be written into the spare drive S-HDD, the configuration is not limited to a time stamp, and it would suffice so as long as it is an identifier capable of writing save-target data, among the save-target data belonging to a RAID group, into the spare drive in the order that it was read into the memory.

For example, a “serial number” column may be provided in substitute for the “time stamp” column 131. The “serial number” column would store identifying information for identifying new/old data of the save-target data read from the data drive D-HDD. Specifically, serial number “0” is assigned to a data group in which the CPU 65 will initially write the save-target data into the spare drive S-HDD. Then, if an overwrite data group is sent from the host apparatus 2 during the writing of the save-target data into the spare drive S-HDD, the CPU 65 assigns serial number “1” to the overwrite data group. Like this, by raising the number of the serial number to be assigned to the new data, it will be possible to manage old data and new data.

(3) Preparation

The advance preparation for writing the save-target data into the spare drive S-HDD is now explained.

Foremost, the administrator sets various types of information to be registered in the drive management information table 10, the data drive management information table 11, and the spare drive management information table 12 stored in the main memory 66 from the management screen 71 of the management terminal 7.

Specifically, the administrator configures the spare drives S-HDD in RAID format. The administrator thereafter sets the association of the data RAID group RG and the spare RAID group S-RG. Here, the setting may be configured such that a plurality of data RAID groups RG share one spare RAID group S-RG. The administrator may also set the RAID level.

As the setting method, the administrator may manually set the data RAID group RG and the spare RAID group S-RG, or the hard disk drives HDD that could not be allocated as the data RAID group RG by the administrator may be automatically set as the spare RAID group S-RG. Moreover, a method of displaying the physical storage location of the hard disk drives HDD on the management screen 71 and having the administrator set the data RAID group RG or the spare RAID group S-RG among the displayed hard disk drives HDD may also be adopted.

(4) Change Processing

The change processing for changing the configuration of the RAID group after the foregoing initialization is now explained. In particular, a case of changing the configuration of the RAID group by adding a hard disk drive HDD is explained. The change processing is executed by the CPU 65 based on the change program 14.

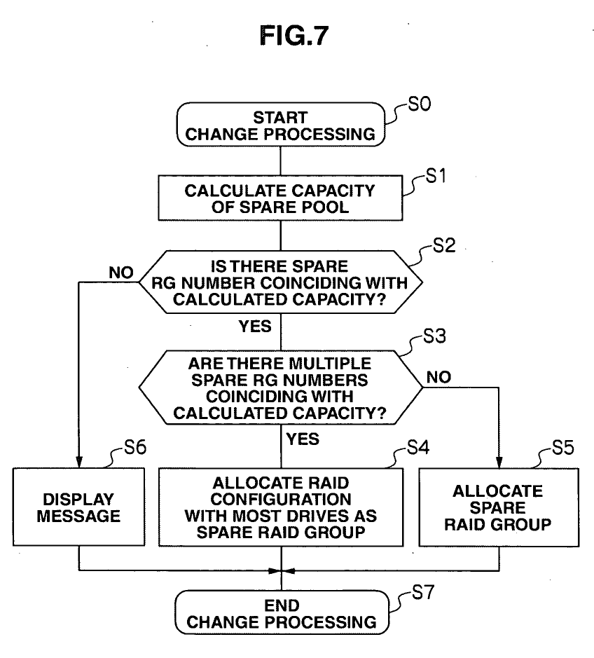

As shown in FIG. 7, the CPU 65 starts the change processing when a hard disk drive HDD is added and the configuration of the data RAID group RG is consequently changed (S0).

Subsequently, the CPU 65 calculates the capacity of the spare RAID group S-RG (hereinafter referred to as the “spare pool capacity”) required by the changed data RAID group RG (S1). According to this embodiment, since the save-target data is written together with the data-related information R into the spare drive S-HDD, as the spare pool capacity, it is necessary to secure a capacity for writing data in an amount that is greater than the save-target data. For example, the CPU 65 sets a capacity obtained by adding 10% to the capacity required for storing the save-target data as the spare pool capacity in order to store the data-related information.

The CPU 65 refers to the spare drive management information table 12, and determines whether there is a spare RAID group number that coincides with the calculated spare pool capacity (S2).

If there is a spare RAID group number that coincides with the calculated spare pool capacity (S2: YES), the CPU 65 additionally determines whether there are a plurality of such spare RAID group numbers (S3).

If there are a plurality of spare RAID group numbers that coincide with the calculated spare pool capacity (S3: YES), the CPU 65 selects the spare RAID group S-RG with the most spare drives S-HDD configuring the spare RAID group S-RG (S4), and then ends the change processing (S7).

Meanwhile, if there are not a plurality of spare RAID group numbers that coincide with the calculated spare pool capacity (S3: NO), the CPU 65 allocates the coinciding spare RAID group S-RG as the spare RAID group S-RG of the changed data RAID group RG (S5), and then ends the change processing (S7).

At step S2, if there is no spare RAID group number that coincides with the calculated spare pool capacity (S2: NO), the CPU 65 sends a message to such effect to the management terminal 7 to notify the administrator (S6),and then ends the change processing (S7).

In the foregoing change processing, although a case was explained where the data-related information R is written into the spare drive S-HDD, if the data-related information R is to be left in the memory, it would suffice to secure a spare pool capacity capable of storing only the save-target data.

(5) Write Processing

The processing of writing the save-target data into the spare drive S-HDD is now explained.

(5-1) Conventional Write Processing

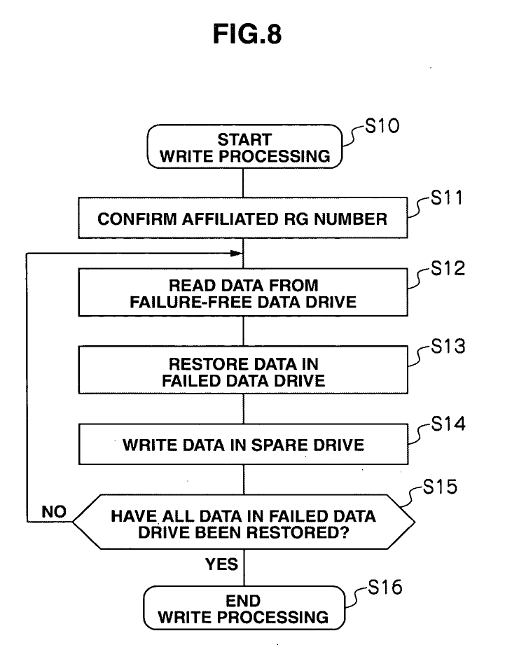

Foremost, the conventional write processing is described with reference to FIG. 8 before explaining the write processing of the present embodiment.

Specifically, the CPU 65 starts the write processing upon detecting a drive failure of a data drive D-HDD (S10). The CPU 65 thereafter confirms to which RAID group number the failed data drive D-HDD belongs (S11).

The CPU 65 reads the data and parity data stored in a failure-free data drive D-HDD of the RAID group to which the failed data drive D-HDD belongs into the main memory 66 (S12). The CPU 65 thereafter calculates the data in the failed data drive D-HDD based on the read data and parity data, and restores the data in the failed data drive D-HDD (S13).

The CPU 65 writes the restored data into a spare drive S-HDD (S14), and executes the write processing until all data in the failed data drive D-HDD are restored (S15: NO).

When the CPU 65 restores all data in the failed data drive D-HDD and writes such data into the spare drive S-HDD (S15: YES), it ends the write processing (S16). Incidentally, the spare drive S-HDD to which the restored data is written is a spare drive S-HDD associated with the RAID group to which the failed data drive D-HDD belongs.

The foregoing process is the routine of conventional write processing.

(5-2) Write Processing

The processing of writing the save-target data into a spare drive S-HDD according to the present embodiment is now explained. This write processing is executed by the CPU 65 based on the write program 15.

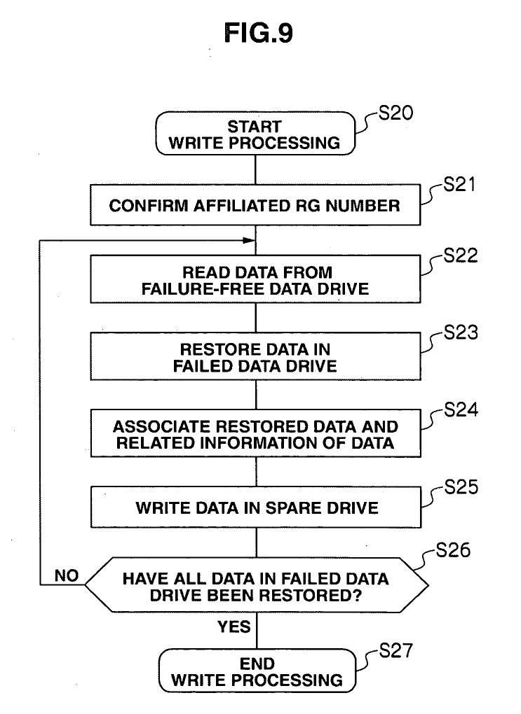

As shown in FIG. 9, the CPU 65 executes the processing from step S20 to step S22 according to the same processing routine as the processing from step S10 to step S12.

The CPU 65 thereafter calculates the data in the failed data drive D-HDD based on the read data and parity data, and restores the data in the failed data drive D-HDD (S23). The restored save-target data is stored in the main memory 66 in the order that the data and parity data were read.

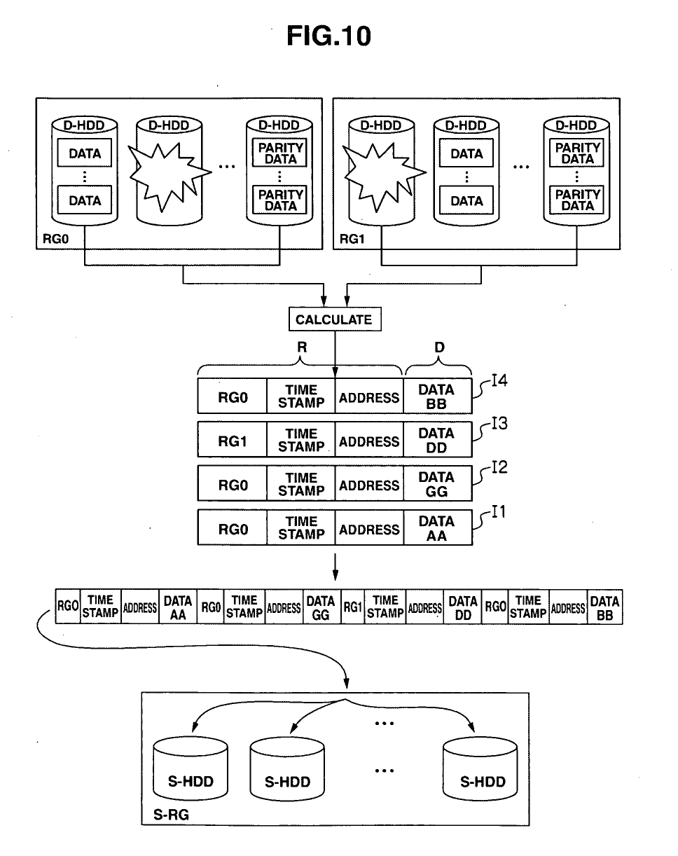

Then, the CPU 65 associates the restored save-target data with the data-related information R, and registers this in the log table 13 (S24). Here, for example, as shown in FIG. 10, when the spare RAID group S-RG “0” is being shared by the data RAID groups RG “0,” “1,” “2” and a failure has occurred in one of the data drives D-HDD belonging respectively to the data RAID groups RG “0” and “1,” at step S24, the save-target data D is associated with the data-related information R in the order that the CPU 65 read the data and parity data.

Subsequently, when the information amount of the row information I1 to I4 of the registered log table 13 exceeds the threshold value of the memory area, the CPU 65 sequentially writes the row information I1 to I4 of the log table 13 into the spare drive S-HDD (S25). The CPU 65 determines the spare drive S-HDD to which data is to be written by referring to the data drive management information table 11 and the spare drive management information table 12.

The threshold value of the memory area is set by the administrator from the management terminal 7; for instance, the setting is configured such that the row information I1 to I4 of the log table 13 is written into the spare drive S-HDD when the information amount of the row information I1 to I4 of the registered log table 13 exceeds 50% of the memory area. Here, since the row information of the log table will be fully written into the spare drive S-HDD, it is possible to prevent the compression of the memory area.

The CPU 65 executes the write processing until all data in the failed data drive D-HDD have been restored (S26: NO).

When the CPU 65 restores all data in the failed data drive D-HDD and writes the save-target data associated with the data-related information R into the spare drive S-HDD (S26: YES), it ends the write processing (S27).

In this embodiment, although the row information of the log table 13 was written into the spare drive S-HDD as is, it is also possible to leave the RG number information, the time stamp information, and the address information (data-related information R) in the main memory 66, and only write the real data into the spare drive S-HDD. In this case, since the data-related information R will be stored near the CPU 65, the speed that the CPU 65 will be able to access the data-related information R will increase. Moreover, since related in formation is stored in the memory, the processing speed will be faster than with a hard disk drive HDD.

Although the log table 13 is stored in the main memory 66 in this embodiment, it may also be stored in the cache memory 63, and there is not particular limitation on the storage location of the memory.

Like this, since the CPU 65 is able to sequentially write a considerable amount of information into the spare drive S-HDD in the order that the data was read into the memory, it will not be necessary to move the magnetic head during the writing, and the processing speed of the storage system 1 can be improved thereby.

(5-3) Reconfiguration Time Setting Processing

As a premise for executing the write processing, it is also possible to set the reconfiguration time from the time that a failure occurred to the time of writing back the restored data to the replaced data drive D-HDD. The reconfiguration time setting processing to be performed in the foregoing case is now explained. The reconfiguration time setting processing is executed by the CPU 65 based on the reconfiguration time program 16.

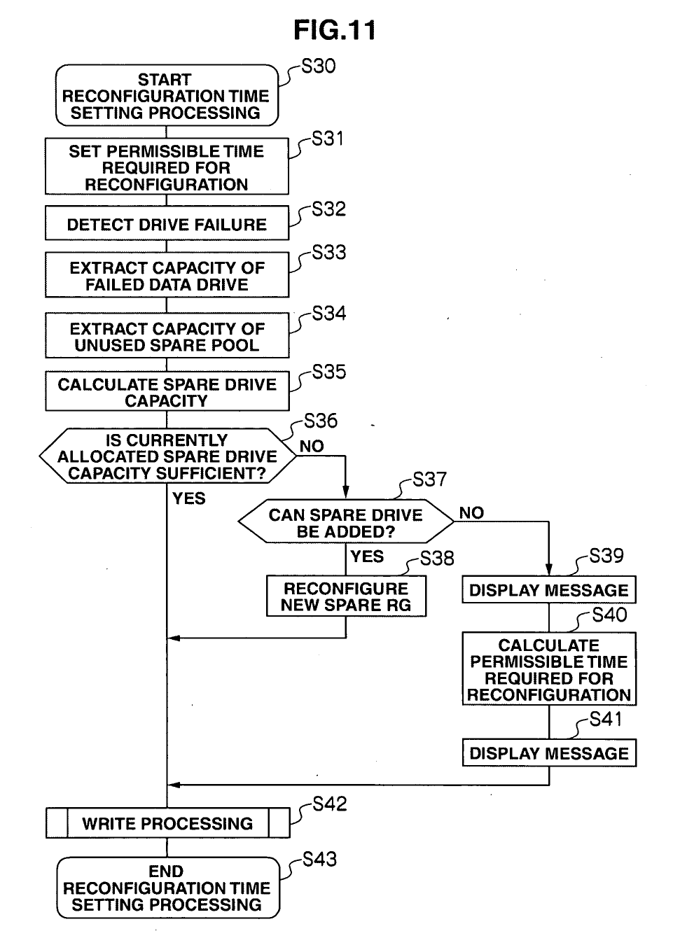

Foremost, as shown in FIG. 11, the administrator sends a setting command to the storage apparatus 4 for setting the permissible time required for reconfiguration from the management screen 71 of the management terminal 7, and starts the reconfiguration time setting processing when the storage apparatus 4 receives the foregoing setting command (S30).

Subsequently, the CPU 65 sets the permissible time required for reconfiguration according to the command from the administrator (S31). When the CPU 65 detects a failed data drive D-HDD (S32), it refers to the drive management information table 10, and extracts the drive capacity of that data drive D-HDD (S33).

The CPU 65 thereafter refers to the data drive management information table 11 and the spare drive S-HDD management information, and extracts an unused spare pool capacity (S34). An unused spare pool capacity is the unused capacity of the spare RAID group S-RG associated with the data RAID group RG to which the failed data drive D-HDD belongs, and refers to the unused capacity of all spare drives S-HDD belonging to that spare RAID group S-RG.

The CPU 65 calculates the spare drive S-HDD capacity for recovering data within the permissible time based on the permissible time for reconfiguring the failed data drive D-HDD, the failed data drive D-HDD capacity, and the unused spare pool capacity that is currently associated (S35).

The CPU 65 determines whether the calculated spare drive S-HDD capacity can be covered by the currently associated unused spare pool capacity (S36). If the calculated spare drive S-HDD capacity can be covered by the unused spare pool capacity (S36: YES), the CPU 65 executes the write processing (S42), and thereafter ends the reconfiguration time setting processing (S43).

Meanwhile, if the calculated spare drive S-HDD capacity cannot be covered by the currently associated unused spare pool capacity (S36: NO), the CPU 65 determines whether there is a spare drive S-HDD that can be added and the unused spare pool capacity can be increased thereby (S37). The CPU 65 refers to the drive management information table 10 and determines that there is a spare drive S-HDD that can be added if there is a hard disk drive HDD that has not been allocated to either the data RAID group RG or the spare RAID group S-RG.

If the CPU 65 determines that there is a spare drive S-HDD that can be added (S37: YES), it adds that spare drive S-HDD, and increases the unused spare pool capacity (S38). Here, in order to reconfigure the spare RAID group S-RG, the CPU 65 updates the registration of the drive management information table 10 and the spare drive management information table 12. The CPU 65 thereafter executes the write processing (S42), and then ends the reconfiguration time setting processing (S43).

If the CPU 65 determines that there is no spare drive S-HDD that can be added (S37: NO), it sends a message to the effect that the permissible time designated by the administrator will lapse with the currently associated unused spare pool capacity to the management terminal 7 in order to notify the administrator (S39).

When the CPU 65 recalculates the reconfiguration time required for the reconfiguration based on the failed data drive D-HDD capacity and the currently associated unused spare pool capacity (S40), it sends the calculated reconfiguration time to the management terminal 7 in order to notify the administrator (S41). The CPU 65 thereafter executes the write processing (S42), and then ends the reconfiguration time setting processing (S43).

Since the write processing to be executed at step S42 is the same as the processing from step S20 to step S26 executed by the CPU 65, the explanation thereof is omitted.

Like this, with the reconfiguration time processing, since the storage apparatus 4 is able to determine whether data can be restored within the reconfiguration time desired by the administrator, it is possible to realize an even more sophisticated storage system 1.

(5-4) Write Update Processing

The write update processing of saving update data sent from the host apparatus 2 to the spare drive S-HDD during the execution of the write processing is now explained. This write update processing is executed by the CPU 65 based on the write program 15.

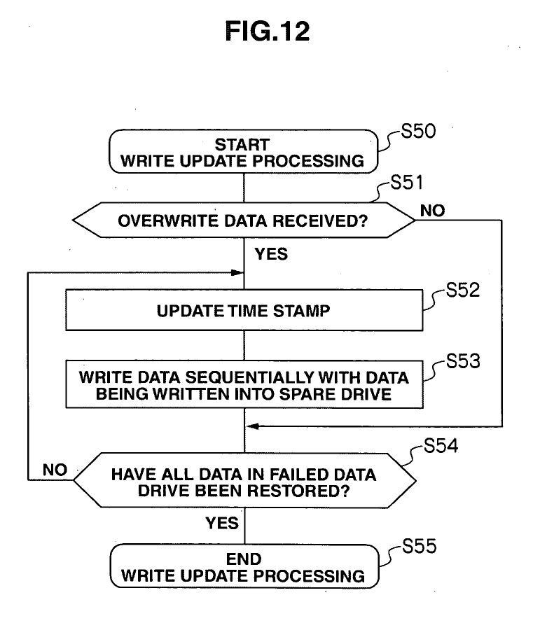

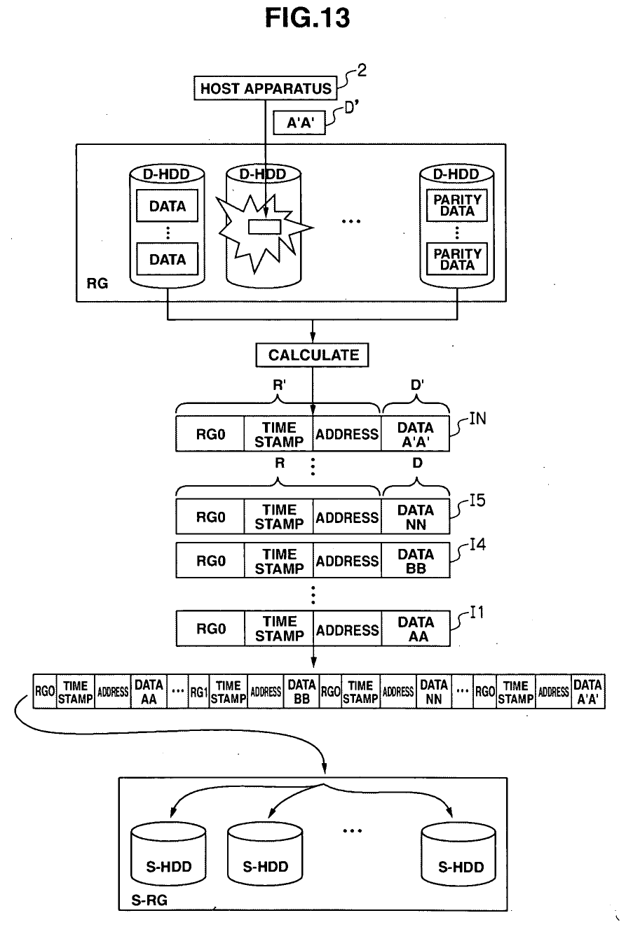

Specifically, as shown in FIG. 12 and FIG. 13, when the storage apparatus 4 receives an overwrite command from the host apparatus 2 for overwriting the data in the failed data drive D-HDD while the CPU 65 is writing the save-target data into the spare drive S-HDD, the CPU 65 starts the write update processing (S50).

Subsequently, the CPU 65 refers to the data drive management information table 11 determines whether the overwrite data D′ for overwriting the data in the failed data drive D-HDD has been received (S51).

If the overwrite data D′ for overwriting the data in the failed data drive D-HDD has been received (S51: YES), the CPU 65 updates the time stamp information of the log table 13 and registers it in the last row of the log table 13 (S52).

The CPU 65 thereafter writes the overwrite data D′ and the overwrite data-related information R into the spare drive S-HDD as the rearmost data IN that is currently being written (S53).

The CPU 65 executes the write processing until all data in the failed data drive D-HDD are restored (S54: NO).

When the CPU 65 restores all data in the failed data drive D-HDD and writes the save-target data associated with the data-related information R into the spare drive S-HDD (S54: YES), it ends the write processing (S55).

Like this, since the CPU 65 registers the overwrite data D′ in the last row of the log table 13, even when an overwrite command is received from the host apparatus 2, a considerable amount of information can be sequentially written into the spare drive S-HDD in the order that the data was read into the memory. Thus, it will not be necessary to move the magnetic head during the writing, and the processing speed of the storage system 1 can be improved thereby.

(6) Copyback Processing

The copyback processing of writing back the save-target data to the replaced data drive D-HDD is now explained. The copyback processing is executed by the CPU 65 based on the copyback program 17.

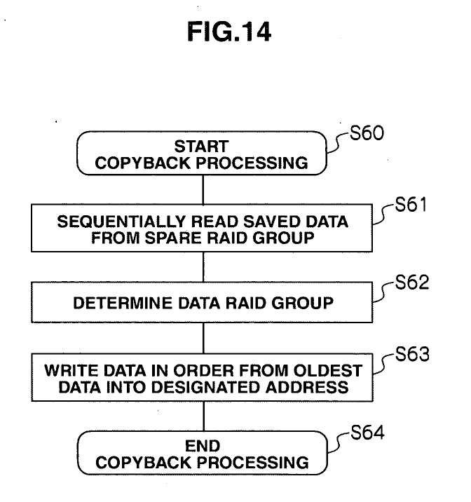

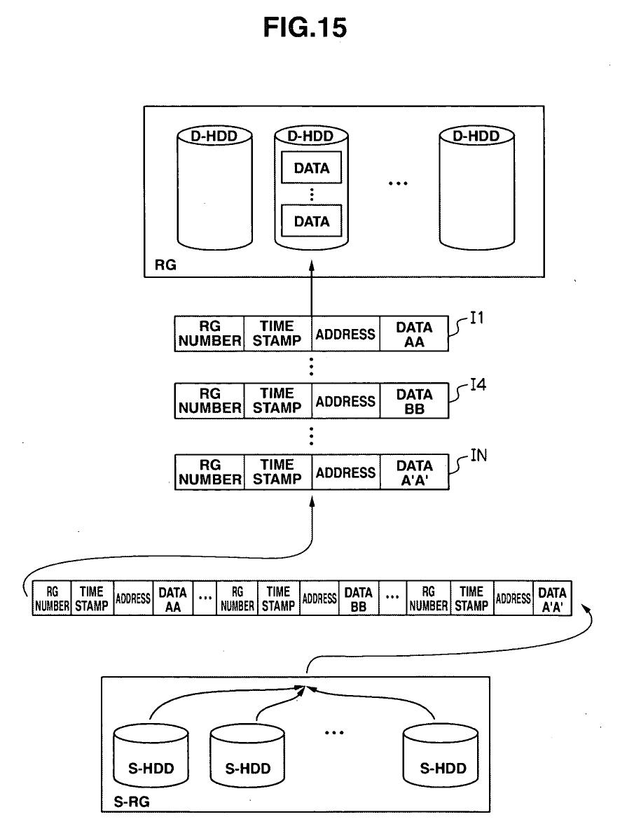

As shown in FIG. 14 and FIG. 15, the CPU 65 starts the copyback processing when the administrator replaces the failed data drive D-HDD with a new data drive D-HDD and receives a notice from the disk controller 64 to the effect that the data drive D-HDD has been replaced (S60).

The CPU 65 sequentially reads the row information I1 to IN of the saved data D and the data-related information R into the main memory 66 from the spare RAID group S-RG storing the saved data (S61).

The CPU 65 thereafter refers to the drive management information table 10 and the RAID group number information among the data-related information R, and decides the data RAID group RG for writing back the saved data to the replaced data drive D-HDD (S62). Here, since the data D and the data-related information R read into the main memory 66 are not organized for each RAID group, the CPU 65 refers to the RAID group number and retrieves the data and the data-related information R corresponding to the decided RAID group.

When the CPU 65 writes back the saved data belonging to the relevant data RAID group RG to the address of the designated data drive D-HDD in order from the oldest data by referring to the time stamp information and the address information (S63), it ends the copyback processing (S64).

Like this, since old data is written back to the data drive D-HDD first, it is possible to recreate the data in the data drive D-HDD while new data is overwritten by necessity.

(7) Effect of Present Embodiment

According to the present embodiment, it is possible to specifically manage the data to be written into the spare RAID group and specifically manage the data capacity and the pool area capacity by realizing a redundant configuration of the spare drive and sequentially writing data into the spare drive. Thus, since data in the failed data drive can be sequentially written into the spare drive, it is possible to manage the storage system efficiently.

Furthermore, it is possible to efficiently manage the storage system since a plurality of RAID groups configured from a plurality of data drives share one spare drive.

The present invention can be broadly applied to a plurality of storage systems or storage system of other modes.

What is claimed is:

1. A storage system, comprising:
a plurality of data drives;
a plurality of spare drives for storing data stored in at least one data drive among the plurality of data drives as save-target data;
one or more RAID groups configured from the plurality of data drives;
one or more spare RAID groups associated with the one or more RAID groups and configured from the plurality of spare drives; and
a write unit configured to write the save-target data into the plurality of spare drives configuring the one or more spare RAID groups in the order that the save-target data was read from the at least one data drive.

2. The storage system according to claim 1, further comprising:
an assignment unit configured to assign save-target data-related information for writing the save-target data into the plurality of spare drives configuring the one or more spare RAID groups in the order that the save-target data was read from the at least one data drive.

3. The storage apparatus according to claim 1,
wherein a plurality of RAID groups are managed by being associated with one spare RAID group.

4. The storage system according to claim 2,
wherein the save-target data-related information includes log information recording the date and time for writing the save-target data into the plurality of spare drives configuring the one or more spare RAID groups.

5. The storage system according to claim 2,
wherein the save-target data-related information includes identifying information for identifying new/old data of the save-target data read from the at least one data drive.

6. The storage system according to claim 1,
wherein the save-target data is written into the plurality of spare drives configuring the one or more spare RAID groups in the order that the save-target data was read from the at least one data drive when the save-target data is stored in an area of the memory over a threshold value.

7. The storage system according to claim 1,
wherein, if overwrite data of the save-target data is received when the save-target data is written into the plurality of spare drives configuring the one or more spare RAID groups in the order that the save-target data was read from the at least one data drive, the overwrite data is sequentially written after the save-target data is written.

8. The storage system according to claim 1,
wherein, when writing back the save-target data stored in the plurality of spare drives to a replaced data drive, the save-target data is written back to the replaced data drive from the oldest save-target data based on the save-target data-related information.

9. A data saving method, comprising:
a step of configuring one or more RAID groups from a plurality of data drives;
a step of storing data stored in at least one data drive among the plurality of data drives as save-target data in a plurality of spare drives;
a step of configuring one or more spare RAID groups associated with one or more spare RAID groups from the plurality of spare drives; and
a step of writing the save-target data into the plurality of spare drives configuring the one or more spare RAID groups in the order that the save-target data was read from the at least one data drive.

10. The data saving method according to claim 9, further comprising:
a step of assigning save-target data-related information for writing the save-target data into the plurality of spare drives configuring the one or more spare RAID groups in the order that the save-target data was read from the at least one data drive

11. The data saving method according to claim 9, further comprising:
a step of associating and managing a plurality of RAID groups and one spare RAID group.

12. The data saving method according to claim 10,
wherein the save-target data-related information includes log information recording the date and time for writing the save-target data into the plurality of spare drives configuring the one or more spare RAID groups.

13. The data saving method according to claim 10,
wherein the save-target data-related information includes identifying information for identifying new/old data of the save-target data read from the at least one data drive.

14. The data saving method according to claim 9, further comprising:
a step of writing the save-target data into the plurality of spare drives configuring the one or more spare RAID groups in the order that the save-target data was read from the at least one data drive when the save-target data is stored in an area of the memory over a threshold value.

15. The data saving method according to claim 9, further comprising:
if overwrite data of the save-target data is received when the save-target data is written into the plurality of spare drives configuring the one or more spare RAID groups in the order that the save-target data was read from the at least one data drive, a step of sequentially writing the overwrite data after the save-target data is written.

16. The data saving method according to claim 9, further comprising:
when writing back the save-target data stored in the plurality of spare drives to a replaced data drive, a step of writing back the save-target data to the replaced data drive from the oldest save-target data based on the save-target data-related information.
